(19) United States
(12) Patent Application Publication
(10) Pub. No.: US 2025/0284971 A1
(43) Pub. Date: Sep. 11, 2025

(54) TRAINING NEURAL NETWORKS THROUGH REINFORCEMENT LEARNING USING MULTI-OBJECTIVE REWARD NEURAL NETWORKS

(71) Applicant: Google LLC, Mountain View, CA (US)

(72) Inventors: Yunxuan Li, San Jose, CA (US); Léonard Hussenot Desenonges, Paris (FR); Le Hou, Sunnyvale, CA (US); Robert Dadashi-Tazehozi, Paris (FR); Sertan Girgin, Chamonix-Mont Blanc (FR); Jin Young Sohn, Jersey City, NJ (US); Siddhartha Brahma, Mountain View, CA (US); Nikola Momchev, Zurich (CH); Sabela Ramos Garea, Leiden (NL); Geoffrey Virgil Cideron, Paris (FR); Yong Cheng, Mountain View, CA (US); Melvin Jose Johnson Premkumar, Sunnyvale, CA (US); Olivier Frédéric Bachem, Zurich (CH)

(21) Appl. No.: 19/072,859

(22) Filed: Mar. 6, 2025

Related U.S. Application Data
(60) Provisional application No. 63/562,221, filed on Mar. 6, 2024.

(51) Int. Cl. G06N 3/092

(52) U.S. Cl. CPC G06N 3/092

(57) ABSTRACT

Methods, systems, and apparatus, including computer programs encoded on computer storage media, for training a neural network through reinforcement learning. One of the methods includes, at each of a plurality of training steps: obtaining one or more training network inputs for the training step; processing the training network inputs using the neural network to generate one or more training network outputs for each of the training network inputs; for each training network output, processing a reward input comprising the training network output using a multi-objective reward neural network to generate a respective reward score for each of a plurality of objectives; for each training network output, generating, from the respective reward scores for each of the plurality of objectives, a combined reward score; and training the neural network through reinforcement learning using the combined reward scores for the training network outputs.

### CROSS-REFERENCE TO RELATED APPLICATION

This application claims priority to U.S. Provisional Application No. 63/562,221, filed on Mar. 6, 2024. The disclosure of the prior application is considered part of and is incorporated by reference in the disclosure of this application.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that trains a neural network through reinforcement learning. In particular, the system trains the neural network through reinforcement learning using a multi-objective reward neural network that generates a respective reward score for each of multiple different objectives.

Particular embodiments of the subject matter described in this specification can be implemented so as to realize one or more of the following advantages.

By training the neural network using combined rewards generated using the multi-objective neural network, the system can improve the effectiveness of the training process, e.g., because the reward signal that is used for reinforcement learning incorporates multiple measures of multiple different aspects of the quality of any given output.

Additionally, because the reward scores for the multiple objectives are generated by the same multi-objective reward neural network and in a single forward pass through the reward neural network, the system can achieve this improvement in training quality without any significant additional computational overhead.

That is, because only a single pass through the multi-objective reward neural network is required, the system does not need to perform any additional forward passes in order to generate the additional reward scores relative to what would be required to compute a single reward score. Because computing forward passes through deep neural networks can be computationally expensive and consume significant memory and processor resources, this allows the system to improve the quality of the training without adding significant computational overhead.

In other words, the system can make use of the multi-objective reward neural network to generate multiple different reward scores in parallel and with a forward pass through a single neural network, achieving a richer training signal without adding latency or other overhead to the reinforcement training process.

Moreover, the system can train the reward neural network on both objectives that have pointwise losses and pairwise losses, improving the accuracy of the reward scores generated by the multi-objective reward neural network and improving the quality of the training of the neural network.

More specifically, by training the multi-objective reward neural network on batches of training data that include both (i) inputs for objectives that have point-wise loss functions and (ii) inputs for objectives that have pair-wise loss functions, the system can effectively train the multi-objective reward neural network on all of the objectives in a single training run, decreasing the computational complexity of the training process and improving the effectiveness of the training, e.g., because information can be propagated between both point-wise and pair-wise objectives.

That is, by training the multi-objective reward neural network jointly on both point-wise objectives and pair-wise objectives, the system performs the training in a more computationally efficient manner, e.g., relative to performing one training run for point-wise objectives and another training run for pair-wise objectives or training separate reward models for point-wise objectives and pair-wise objectives.

Additionally, the system can generate most or all of the training data for the multi-objective reward neural network using an already-trained model, e.g., rather than requiring human labeling or additional model training, allowing the multi-objective reward neural network to be effectively trained on a variety of different tasks. For example, the system can generate the pairs of training reward inputs for pair-wise objectives by chain-of-thought prompting a large language model. As another example, the system can also generate the single training reward inputs for point-wise objectives by chain-of-thought prompting the large language model.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example neural network training system.

FIG. 2 shows an example of the architecture of the multi-objective reward neural network.

FIG. 3 is a flow diagram of an example process for training the neural network using reinforcement learning.

FIG. 4 is a flow diagram of an example process for generating reward scores using the multi-objective reward neural network.

FIG. 5 is a flow diagram of an example process for training the multi-objective reward neural network.

Like reference numbers and designations in the various drawings indicate like elements.

### DETAILED DESCRIPTION

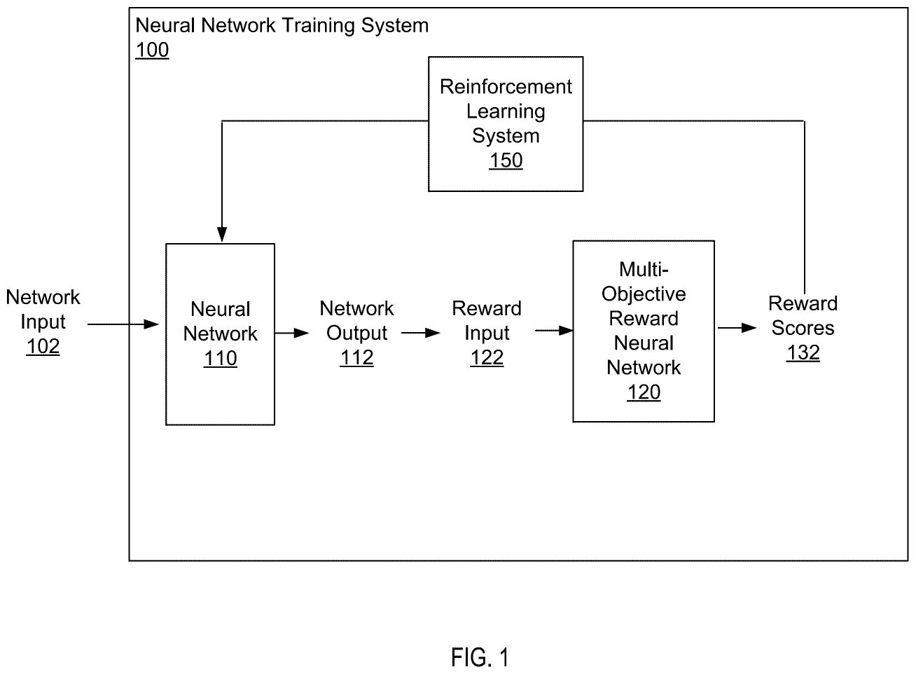

FIG. 1 is a block diagram of an example neural network training system 100. The neural network training system 100 is an example of a system implemented as computer programs on one or more computers in one or more locations in which the systems, components, and techniques described below are implemented.

The system 100 trains a neural network 110 through reinforcement learning.

For example, the neural network 110 can be a neural network that is configured to processes input sequences to perform one or more machine learning tasks. One example of such a neural network is a language model neural network, e.g., a large language model (LLM) neural network or other appropriate language model neural network.

The neural network 110 can be configured through training to perform any kind of machine learning task, i.e., can be configured to receive any kind of input sequence and to generate any kind of score, classification, or regression output based on the input sequence.

In some situations, the neural network 110 can be referred to as an auto-regressive neural network, i.e., because the neural network 110 auto-regressively generates an output sequence of tokens. More specifically, the auto-regressively generated output is created by generating each particular token in the output sequence conditioned on a current input sequence that includes any tokens that precede the particular token in the output sequence, i.e., the tokens that have already been generated for any previous positions in the output sequence that precede the particular position of the particular token.

For example, the neural network 110 can be an auto-regressive attention neural network that includes (i) a plurality of attention blocks that each apply a self-attention operation and (ii) an output subnetwork that processes an output of the last attention block to generate the score distribution.

In this example, the neural network 110 can have any of a variety of Transformer-based neural network architectures. Examples of such architectures include those described in J. Hoffmann, et al.; J. W. Rac, et al., Scaling language models: Methods, analysis & insights from training gopher. CoRR, abs/2112.11446, 2021; Colin Raffel, et al., Exploring the limits of transfer learning with a unified text-to-text transformer. arXiv preprint arXiv: 1910.10683, 2019; Daniel Adiwardana, et al., Towards a human-like open-domain chatbot. CoRR, abs/2001.09977, 2020; and Rohan Anil, et al., Gemini: A Family of Highly Capable Multimodal Models, arXiv preprint arXiv: 2312.11805, 2023.

Examples of tasks that the neural network 110 can perform are described below.

More specifically, the system 100 trains the neural network 110 through reinforcement learning using a multi-objective reward neural network 120.

The multi-objective reward neural network 120 is a neural network that is configured to receive a reward input 122 that includes a network output, e.g., a network output 112 generated by the neural network 110 by processing a given network input 102, and to process the reward input 122 to generate a respective reward score 132 for each of multiple different objectives.

The reward score 132 for each objective measures how well the network output 112 satisfies the corresponding objective.

In other words, the reward score 132 for an objective is a score that measures the degree to which the network output 112 satisfies the corresponding objective.

In some cases, the reward input 122 includes only the network output 112 while, in other cases, the reward input 122 includes additional information.

For example, the reward input 122 can also include the given network input 102 that was processed to generate the network output 112.

As another example, the reward input 122 can also include a prompt or other instruction that instructs the reward neural network 120 to generate an appropriate output.

Thus, the multi-objective reward neural network 120 can generate a respective reward score 132 for each of the multiple objectives in a single forward pass through the reward neural network 120. In other words, the multi-objective reward neural network 120 can generate multiple different reward scores 132 for different objectives in parallel, i.e., in a single forward pass.

The objectives in the set of multiple objectives can be any of a variety of objectives that measure various properties of a given network output 112.

For example, one of the objectives can measure how responsive the network output 112 is to the corresponding network input 102. In other words, the objective can measure the “responsiveness” of the network output 112. That is, the objective measure how aligned the network output 112 is to the network input 102. For example, if the network input 102 includes a question, the objective can measure the degree to which the network output 112 answers the question, e.g., independent of whether the answer is correct. More generally, if the network input 102 specifies a task, the objective can measure the degree to which the network output 112 attempts to perform the task.

As another example, another of the objectives can measure the degree to which the network output 112 conforms to a specified format for network outputs 112 generated by the neural network 110.

As another example, another of the objectives can measure the sensibility of the network output 112, e.g., whether the network output 112 makes sense or is otherwise able to be understood by users.

As another example, another of the objectives can measure the usefulness of the network output 112, either dependent on or independent of the network input 102.

As another example, another of the objectives can measure the accuracy or correctness of the network output 112, e.g., whether the network output 112 is an accurate or correct response to the network input 102.

Any of a variety of other objectives are possible.

The multi-objective reward neural network 120 can generally have any appropriate architecture that allows the multi-objective reward neural network 120 to map a reward input to multiple different reward scores in a single forward pass.

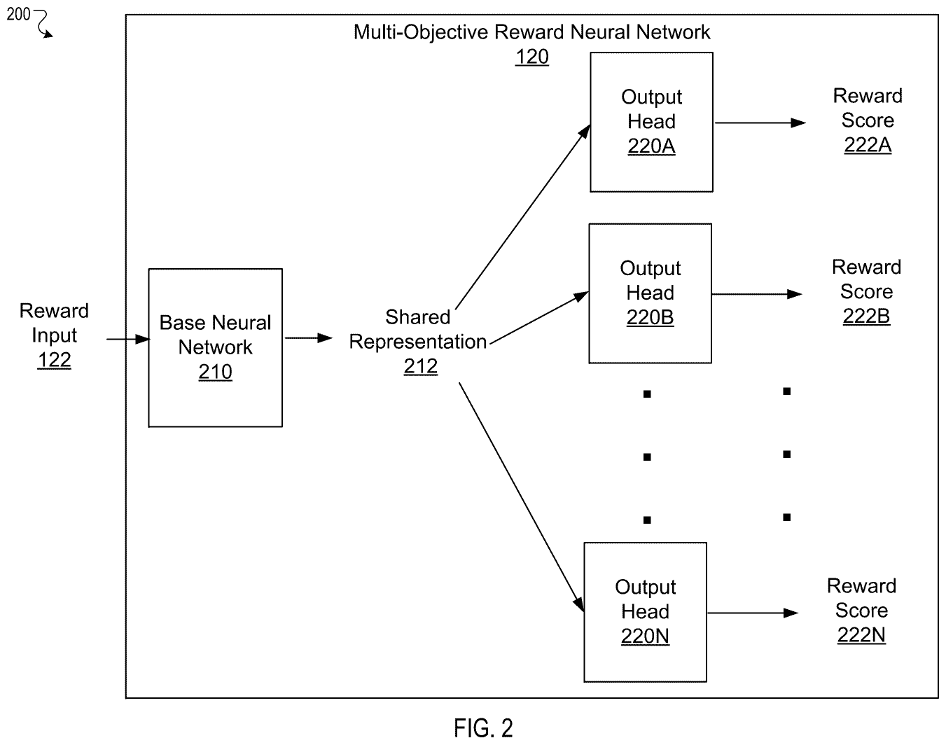

One example of such an architecture is described below with reference to FIG. 2.

Once the multi-objective reward neural network 120 has generated the reward scores 132, a reinforcement learning system 150 within the system 100 uses the reward scores 132 to train the neural network 110 through reinforcement learning.

Thus, the reinforcement learning system 150 uses the reward scores 132 to train the neural network 110 to generate network outputs 112 that optimize a specified combination of the multiple objectives.

For example, the reinforcement learning system 150 can determine a weighted sum or other weighted combination of the reward scores 132, with the weights in the combination specifying the impact of the corresponding objectives on the outputs generated by the neural network 110, and then use the weight combination as the final reward for the reinforcement learning training.

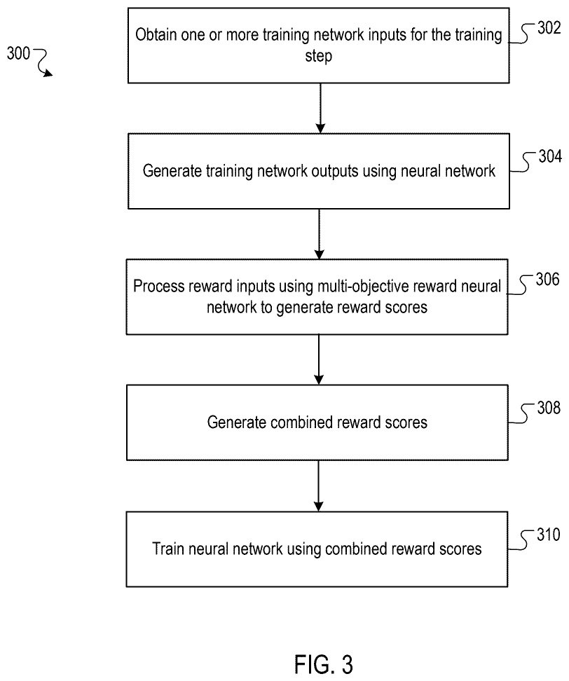

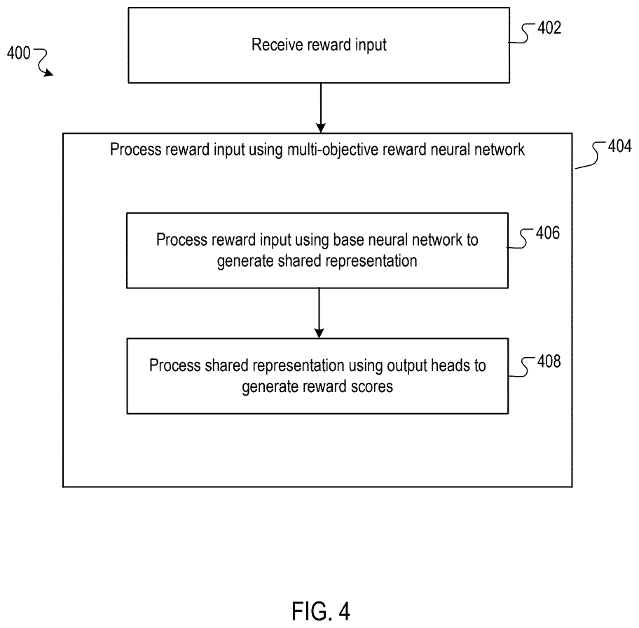

Using the multi-objective reward neural network 120 to train the neural network 110 through reinforcement learning is described in more detail below with reference to FIGS. 3 and 4.

In some implementations, prior to the training through reinforcement learning, the neural network 110 has been pre-trained through unsupervised learning, supervised learning, or both, e.g., by the system 100 or by another training system. For example, the neural network 110 can have been trained on one or more of a next token prediction objective on an unlabeled data set, a supervised fine-tuning objective on a labeled data set, an instruction tuning data set, and so on. Thus, in these implementations, the system 100 trains the neural network 110 using the multi-objective reward neural network 120 to “fine-tune” the neural network 110 starting from pre-trained values of the parameters of the neural network 110.

Prior to using the multi-objective reward neural network 120 to train the neural network 110, the system 100 or another training system trains the multi-objective reward neural network 120 on a set of reward model training data.

The reward model training data generally includes a respective training data set for each of the multiple objectives.

More specifically, each of the plurality of objectives has a corresponding loss function and the multi-objective neural network 120 has been trained on, for each of the plurality of objectives, a respective training data set for the objective using the corresponding loss function for the objective.

The plurality of objectives can include pair-wise objectives, point-wise objectives, or both.

A pair-wise objective is an objective that has a corresponding loss function that is a pair-wise loss function that compares respective reward scores for the pair-wise objective for two reward inputs. That is, the training data for a pair-wise objective includes multiple pairs of training reward inputs and, for each pair, preference data that indicates which reward input in the pair should be assigned the higher reward score, i.e., which is the “preferred” training reward input in the pair.

A point-wise objective is an objective that has a corresponding loss function that is a point-wise loss function that measures a respective reward score for the point-wise objective for a single reward input. That is, the training data for a point-wise objective includes multiple training reward inputs and, for each training reward input, a target reward score that should be generated for the training reward input.

More specifically, the training system 100 or the other training system trains the multi-objective neural network 120 in a manner that can effectively incorporate both pair-wise and point-wise objectives, improving the accuracy of the reward scores generated by the multi-objective reward neural network 120 and improving the quality of the training of the multi-objective reward neural network 120.

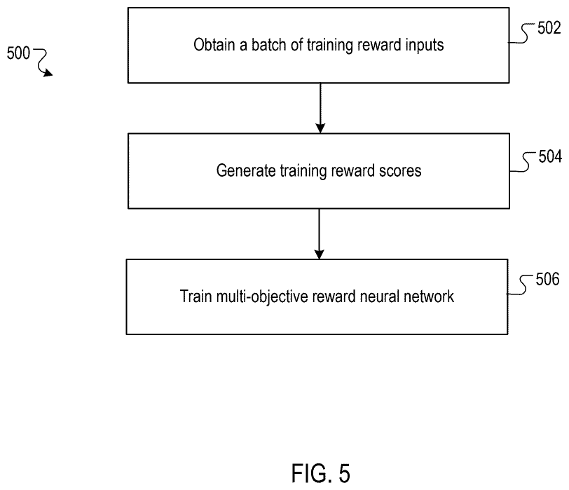

This training is described in more detail below with reference to FIG. 5.

In some cases, the training system 100 or the other training system obtains some or all of the training data for the objectives. For example, the system 100 can obtain a data set of labeled training reward inputs or pairs of training reward inputs that have been labeled by users or by previously-trained single-task reward models.

In some cases, the training system 100 or the other training system can generate some or all of the training data for the objectives using an already-trained model, e.g., rather than requiring human labeling or additional model training, allowing the training system to effectively train the multi-objective reward neural network 120 on a variety of different objectives even when labeled training data for a given objective is not available or is sparse.

For example, the training system can generate the pairs of training reward inputs for pair-wise objectives by chain-of-thought prompting a large language model. That is, for a given pair-wise objective, the system can provide, as input to the large language model, a prompt that instructs the large language model to perform multiple reasoning steps in order to first generate a network input, then generate two different network outputs for the network input, and then generate preference data that indicates which of the two different network outputs would be preferred according to the given pair-wise objective.

As another example, the system can generate the single training reward inputs for point-wise objectives by chain-of-thought prompting the large language model. That is, for a given point-wise objective, the system can provide, as input to the large language model, a prompt that instructs the large language model to perform multiple reasoning steps in order to first generate a network input, then generate a network output for the network input, and then generate a target reward score that indicates how well the network output satisfies the given point-wise objective.

FIG. 2 shows an example 200 of the architecture of the multi-objective reward neural network 120.

In the example of FIG. 2, the neural network 120 includes a base neural network 210 that is shared between the plurality of objectives and a respective output head 220A-N for each of N objectives.

To process a reward input 122 using the multi-objective reward neural network 120, the system 100 can process the reward input 122 using the base neural network 210 to generate a shared representation 212 of the reward input 122. The shared representation 212 can be, e.g., an embedding vector or other ordered collection of numerical values that represents the reward input 122.

For example, the base neural network 210 can be a language model neural network, e.g., having one of the architectures described above with reference to the neural network 110, and the shared representation 212 can be a representation of a last token in the reward input 122 generated by the language model neural network, e.g., the output of the last self-attention layer block of the language model neural network.

The system 100 can then process the shared representation 212 using the respective output head 220A-N for each of the plurality of objectives to generate the respective reward scores 222A-N for the plurality of objectives.

As a particular example, the respective output heads 220A-N can each include a respective linear layer having a respective weight tensor. That is, the i-th output head 220A-N includes a linear layer that operates on the shared representation h to generate the reward score (or a logit that can be mapped to the reward score by an activation function) for the i-th objective by computing the product Wᵢx and, optionally, adding a bias b; to the result, where Wᵢ is the weight tensor for the i-th output head. Thus, in this example each Wᵢ is a 1×d row vector while h is a d×1 column vector.

In this example, to decrease inference latency and further increase parallelization, rather than independently processing the shared representation 212 using each of the output heads 220A-N, the system 100 can process the shared representation 212 using a combined linear layer that has a combined weight tensor that is composed of the respective weight tensors for the respective linear layers for each of the plurality of objectives to generate the respective reward scores for the plurality of objectives. That is, the outputs of the linear layer can either be the respective reward scores or respective logits that can be mapped to the reward scores by apply an element-wise activation function, e.g., a sigmoid function or a tanh function.

In other words, when each Wᵢ is a 1×d row vector while h is a d×1 column vector, rather than computing multiple separate products Wᵢx, the system can instead compute a single combined product Cx, where C is the combined weight tensor and is a N×d matrix that has as its rows the respective Wᵢ row vectors for the N output heads 220A-N.

In some implementations, the system deploys the multi-objective reward neural network on a set of one or more hardware accelerators, e.g., graphics processing units (GPUs), tensor processing units (TPUs), or other ASICs that perform matrix multiplication in hardware. In these implementations, the system can generate the single combined product as a single matrix multiplication in hardware rather than performing separate multiplications for the different output heads. The system can therefore exploit the efficient matrix multiplication capability of hardware accelerators.

Thus, as can be seen in the example of FIG. 2, the system 100 can use the neural network 120 to efficiently generate reward scores for multiple different objectives in a single forward pass through a single neural network, e.g., rather than requiring multiple different forward passes through separate, single-objective reward models.

FIG. 3 is a flow diagram of an example process 300 for training a neural network through reinforcement learning. For convenience, the process 300 will be described as being performed by a system of one or more computers located in one or more locations. For example, a neural network training system, e.g., the neural network training system 100 of FIG. 1, appropriately programmed in accordance with this specification, can perform the process 300.

More specifically, the system performs the training across multiple training steps. At each training step, the system performs the process 300 in order to train the neural network, i.e., to update the values of some or all of the parameters of the neural network.

By repeatedly performing the process 300, the system trains the neural network to generate network outputs that satisfy the multiple different objectives.

The system obtains one or more training network inputs for the training step, e.g., by sampling the training network inputs from a larger data set of training network inputs that are available to the system (step 302).

The system processes the training network inputs using the neural network to generate one or more training network outputs for each of the training network inputs (step 304).

That is, in some cases, the system generates a single training network output for each training network input by processing the training network input using the neural network.

In some other cases, the system can generate multiple different training network outputs for each training network input. For example, when the neural network is an auto-regressive neural network, the system can generate multiple different training network outputs due to stochasticity resulting in sampling the output at each auto-regressive generation step. That is, when generating any given training network output, at each generation time step, the system can sample an output from the probability distribution generated by the neural network at the generation time step instead of, e.g., greedily selecting the output with the highest probability. As a result, different training network outputs for a given training network input will generally be different from one another.

For each training network output, the system processes a reward input that includes the training network output using the multi-objective reward neural network to generate a respective reward score for each of the plurality of objectives (step 306).

As described above, in some cases, the reward input includes only the training network output while, in other cases, the reward input also includes additional information. For example, the reward input can also include the given network output that was processed to generate the network output. As another example, the reward input can also include a prompt or other instruction that instructs the reward neural network to generate an appropriate output.

For each training network output, the system generates, from the respective reward scores for each of the plurality of objectives, a combined reward score (step 308).

For example, the system can compute the combined reward score as a weighted sum of the respective reward scores.

As another example, the system can compute the reward scores as a weighted sum of (i) the respective reward scores and (ii) one or more other reward scores from other sources, e.g., reward scores generated through hard-coded or heuristic-based reward functions.

The weights in the weighted sum can be received as input by the system or the system can determine the weights, e.g., through a hyperparameter search prior to training.

The system then trains the neural network through reinforcement learning using the combined reward scores for the training network outputs (step 310).

The system can generally use any appropriate reinforcement learning objective to perform the training, e.g., can train the neural network on any appropriate objective that includes a term that is based on expected rewards for network outputs generated by the neural network.

For example, the objective can include a first term that encourages the neural network to assign higher likelihoods to training network outputs that have higher combined rewards. For example, the first term can be equal to the combined reward or can be equal to the product of a scalar weight value and the combined reward.

As another example, the objective can include a second term that penalizes the neural network for generating likelihoods that deviate from likelihoods generated by a reference neural network.

For example, as described above, the system can train the neural network to “fine-tune” the neural network starting from a pre-trained neural network. In this example, the reference neural network can be the pre-trained neural network. In another example, the reference neural network can be a different, already-trained neural network that generates the same type of output as the neural network being trained.

For example, the second term can be based on the ratio between (i) the probability assigned to a given network output by the neural network being trained and (ii) the probability assigned to the given network output by the reference neural network. For example, the second term can be equal to the logarithm of the ratio or equal to the product between a scalar weight value and the logarithm of the ratio.

FIG. 4 is a flow diagram of an example process 400 for processing a reward input using the multi-objective reward neural network. For convenience, the process 400 will be described as being performed by a system of one or more computers located in one or more locations. For example, a neural network training system, e.g., the neural network training system 100 of FIG. 1, appropriately programmed in accordance with this specification, can perform the process 400.

The system receives a reward input that includes a training network output generated by the neural network that is being trained (step 402). As described above, in some cases, the reward input includes only the training network output while, in other cases, the reward input also includes additional information. For example, the reward input can also include the given network input that was processed to generate the network output. As another example, the reward input can also include a prompt or other instruction that instructs the reward neural network to generate an appropriate output.

The system then processes the reward input the multi-objective reward neural network to generate a respective reward score for each of the plurality of objectives (step 404).

For example, as described above, the multi-objective reward neural network can include a base neural network that is shared between the plurality of objectives and a respective output head for each of the plurality of objectives.

In this example, to generate the respective reward scores, the system processes the reward input using the base neural network to generate a shared representation of the reward input (step 406) and then processes the shared representation using the respective output head for each of the plurality of objectives to generate the respective reward scores for the plurality of objectives (step 408).

Thus, the system can use the multi-objective reward neural network to generate the reward scores for each objective in parallel in a single forward pass through a single neural network.

In some implementations, the system can further reduce the latency of generating the reward scores by representing the processing of the respective output heads using a combined linear layer that has a combined weight tensor composed of the respective weight tensors for the respective linear layers for each of the plurality of objectives. That is, rather than independently process the shared representation using each output head, the system can process the shared representation using the combined linear layer that has the combined weight tensor to generate the respective reward scores for the plurality of objectives.

FIG. 5 is a flow diagram of an example process 500 for training the multi-objective reward neural network. For convenience, the process 500 will be described as being performed by a system of one or more computers located in one or more locations. For example, a training system, e.g., the training system 100 of FIG. 1, appropriately programmed in accordance with this specification, can perform the process 500.

The system can repeatedly perform the process 500 to train the multi-objective reward neural network.

The system obtains a batch of training reward inputs (step 502). Each training reward input corresponds to a respective one of the plurality of objectives.

For example, when the objectives include a pair-wise objective and a point-wise objective, the training reward inputs in the batch can include (i) a training reward input for the point-wise objective and (ii) a pair of training reward inputs for the pair-wise objective.

For each training reward input that corresponds to a point-wise objective, the system generally also obtains a target reward score for the training reward input, i.e., the score that should be generated by the reward neural network by processing the training reward input.

For each pair of training reward inputs that correspond to a pair-wise objective, the system generally also obtains preference data identifying a preference between the pair of training reward inputs. For example, the preference data can directly identify which of the pair of training reward inputs is preferred or can specify respective target scores for each of the training reward inputs in the pair.

For example, the system can generate the batch of training reward inputs by sampling a respective specified number of inputs corresponding to each of the multiple objectives from the training data for the objective.

As another example, the system can generate the batch of training reward inputs by sampling a specified total number of reward inputs from a “combined” set of training data that includes the training data for all of the objectives.

As yet another example, the system can generate the batch of training reward inputs by first sampling a specified number of the objectives, and then sampling a respective specified number of inputs corresponding to each of the sampled objectives from the training data for the objective.

The system processes each of the training reward inputs in the batch using the reward model neural network to generate a respective training reward score for each of the training reward inputs, e.g., as described above with reference to FIGS. 2 and 4 (step 504).

The system trains the reward neural network using the training reward scores (step 506).

In particular, for each point-wise objective that has one or more corresponding training reward inputs in the batch, the system can determine a gradient of the point-wise loss function for the point-wise objective using the training reward score(s) for the one or more training reward inputs for the point-wise objective.

As a particular example, the system can determine, e.g., through backpropagation, a gradient of the point-wise loss function with respect to (i) the parameters of the output head for the objective and (ii) the parameters of the base neural network.

The point-wise loss function can be any appropriate loss function that, for each training reward input for the objective, measures the error between the training reward score for the training reward input and the target score for the objective. For example, the loss function can be a mean squared error loss or a mean absolute error loss.

For each pair-wise objective that has one or more corresponding pairs of training reward inputs in the batch, the system can determine a gradient of the pair-wise loss function for the pair-wise objective using the training reward scores for the pair(s) of training reward inputs for the pair-wise objective.

As a particular example, the system can determine, e.g., through backpropagation, a gradient of the pair-wise loss function with respect to (i) the parameters of the output head for the objective and (ii) the parameters of the base neural network.

The pair-wise loss function can be any appropriate loss function that, for each pair of training reward inputs for the objective, measures the error between a preference defined by the training reward scores for the training reward inputs in the pair and the preference specified by the preference data for the pair.

The system can then train the reward neural network using the gradients for the first and point-wise objectives.

For example, the system can determine a combined gradient with respect to each parameter of the neural network by summing, averaging, or otherwise combining the gradients with respect to the parameter for the corresponding objectives and can then apply an optimizer, e.g., stochastic gradient descent, Adam, Adafactor, or another appropriate optimizer, to the combined gradients to update the values of the parameters of the neural network.

In some cases, prior to training the reward neural network by repeatedly performing the process 500, the base neural network has been pre-trained as part of a different neural network, e.g., as part of a language model neural network.

Some examples of machine learning tasks that the neural network 110, i.e., the neural network that is being trained using the multi-objective reward neural network, can be configured to perform follow. That is, the neural network 110 can be trained to carry out any of the following tasks and where inputs and outputs are referred to below, these can be training inputs and training outputs.

In any of the implementations below, the neural network may be deployed as part of a chat bot, dialogue agent, or other software tool that receives inputs from users and provides outputs in response to the received input, e.g., as part of a conversation or dialogue. In these implementations, the input sequences received by the neural network are (generated from) user inputs and the output sequences generated by the neural network can be used to generate responses to the user inputs.

In implementations the neural network may be configured as, or include, a generative (large) language model or a multi-modal model, e.g., a visual and language model, to perform these example machine learning tasks.

In some cases, the neural network is a neural network that is configured to perform an image processing task, i.e., receive an input image and to process the input image, e.g., process the pixel values of the input image, to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories. In some other cases, the neural network is a neural network that is configured to perform an image generation task, where the input is a conditioning input and the output is a sequence of intensity value inputs for the pixels of an image.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. The vocabulary for the input tokens may be words, wordpieces or characters of the first language, and the vocabulary for the output tokens may be words, wordpieces or characters of the other language. As a particular example, the task may be a multi-lingual machine translation task, where a single neural network is configured to translate between multiple different source language-target language pairs. In this example, the source language text may be augmented with an identifier that indicates the target language into which the neural network should translate the source language text.

Some implementations may be used for automatic code generation. For example the input tokens may represent words, wordpieces or characters in a first natural language and the output tokens may represent instructions in a computer programming or markup language, or instructions for controlling an application program to perform a task, e.g., build a data item such as an image or web page.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can be a classification of the spoken utterance into one of a plurality of categories, for example an identity of the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient. Such electronic health data may, for example, comprise one or more sequences of physiological data taken from a patient, with the output being a corresponding prediction that relates to those sequences of data. Examples of physiological data and a corresponding prediction include: blood glucose measurements, with the prediction being a predicted future blood glucose measurement or the prediction of a hyper- or hypo-glycemic event; a heart rate, with the prediction being the presence or absence of a heart condition, or a future cardiac event; blood pressure measurements, with the prediction being the risk of a future heart condition; or the like.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

In some implementations the input sequence represents data to be compressed, e.g., image data, text data, audio data, or any other type of data; and the output sequence a compressed version of the data. The input and output tokens may each comprise any representation of the data to be compressed/compressed data, e.g., symbols or embeddings generated/decoded by a respective neural network.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent. The observations may comprise sensor data captured by sensors associated with (e.g., part of) the agent, for example visual data, LIDAR data, sonar data, agent configuration data (e.g., joint angles), agent orientation data, or the like.

In some implementations, the environment is a real-world environment, the agent is a mechanical (or electro-mechanical) agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example captured by a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation, e.g., steering, and movement, e.g., braking and/or acceleration of the vehicle.

In some implementations the environment is a simulation of the above-described real-world environment, and the agent is implemented as one or more computers interacting with the simulated environment. For example, a system implementing the neural network may be used to select actions in the simulated environment during training or evaluation of the system and, after training, or evaluation, or both, are complete, the action selection policy may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations, as described above, the agent may not include a human being (e.g., it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, a system implementing the neural network may output to the human user, via the digital assistant, instructions for actions for the user to perform at each of a plurality of time steps. The instructions may for example be generated in the form of natural language (transmitted as sound and/or text on a screen) based on actions chosen by the system. The system chooses the actions such that they contribute to performing a task. A monitoring system (e.g., a video camera system) may be provided for monitoring the action (if any) which the user actually performs at each time step, in case (e.g., due to human error) it is different from the action which the system instructed the user to perform. Using the monitoring system the system can determine whether the task has been completed. The system may identify actions which the user performs incorrectly with more than a certain probability. If so, when the system instructs the user to perform such an identified action, the system may warn the user to be careful. Alternatively or additionally, the system may learn not to instruct the user to perform the identified actions, i.e., ones which the user is likely to perform incorrectly.

More generally, the digital assistant instructing the user may comprise receiving, at the digital assistant, a request from the user for assistance and determining, in response to the request, a series of tasks for the user to perform, e.g., steps or sub-tasks of an overall task. Then for one or more tasks of the series of tasks, e.g., for each task, e.g., until a final task of the series the digital assistant can be used to output to the user an indication of the task, e.g., step or sub-task, to be performed. This may be done using natural language, e.g., on a display and/or using a speech synthesis subsystem of the digital assistant. Visual, e.g., video, and/or audio observations of the user performing the task may be captured, e.g., using the digital assistant. A system as described above may then be used to determine whether the user has successfully achieved the task e.g., step or sub-task, i.e., from the answer as previously described. If there are further tasks to be completed the digital assistant may then, in response, progress to the next task (if any) of the series of tasks, e.g., by outputting an indication of the next task to be performed. In this way the user may be led step-by-step through a series of tasks to perform an overall task. During the training of the neural network, training rewards may be generated e.g., from video data representing examples of the overall task (if corpuses of such data are available) or from a simulation of the overall task.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g., a conversation agent such as Sparrow (Glaese, et al., arXiv: 2209.14375) or Chinchilla (Hoffmann, et al., arXiv: 2203.15556). The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks, e.g., of a series of tasks, e.g., until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g., to stop capturing observations.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

In some cases, the machine learning task is a multi-modal processing task that requires processing multi-modal data. In general, multi-modal data is a combination of two or more different types of data, e.g., two or more of audio data, image data, text data, or graph data. As one example the multi-modal data may comprise audio-visual data, comprising a combination of pixels of an image or of video and audio data representing values of a digitized audio waveform. As another example the multi-modal data may comprise a combination of i) text data representing text in a natural language and ii) pixels of an image or of video or audio data representing values of an audio waveform. Optionally, but not necessarily, the different types of data may represent the same or overlapping objects using the different modalities (types), and when processing multi-modal data the data may be mapped into a common embedding space.

As a particular example, the task is a multi-modal processing task that requires processing both text and image inputs, so that the neural network includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

More generally, the multi-modal processing task may correspond to any of the tasks previously described for any of the types of data making up the multi-modal combination. For example, an accuracy of the previously described tasks may be increased when the task is applied to multi-modal data combining the data for which the task has been previously described and another type of data. For example detection or classification of an object or event may be improved when data of multiple different types (modalities) is processed.

More generally, the task to be performed by the neural network can be specified by the input sequence. As a particular example, the input sequence can include a prompt or an instruction that specifies the task that is to be performed by the neural network. Optionally, in this example, the input sequence also includes context for performing the task. That is, the neural network may be configured to perform multiple different ones of the above tasks by virtue of being provided different prompts that instruct the neural network to perform different tasks.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
training, through reinforcement learning, a neural network that is configured to receive a network input and to process the network input to generate a network output, the training comprising, at each of a plurality of training steps:
obtaining one or more training network inputs for the training step;
processing the training network inputs using the neural network to generate one or more training network outputs for each of the training network inputs;
for each training network output, processing a reward input comprising the training network output using a multi-objective reward neural network to generate a respective reward score for each of a plurality of objectives;
for each training network output, generating, from the respective reward scores for each of the plurality of objectives, a combined reward score; and
training the neural network through reinforcement learning using the combined reward scores for the training network outputs.

2. The method of claim 1, wherein, prior to the training through reinforcement learning, the neural network has been pre-trained through one or more of unsupervised learning or supervised learning.

3. The method of claim 1, wherein the neural network is a language model neural network.

4. The method of claim 3, wherein the neural network is an auto-regressive language model neural network.

5. The method of claim 4, wherein the neural network is an encoder-decoder or decoder-only Transformer neural network.

6. The method of claim 1, wherein the multi-objective reward neural network comprises:
a base neural network that is shared between the plurality of objectives; and
a respective output head for each of the plurality of objectives.

7. The method of claim 6, wherein processing the reward input comprising the training network output using the multi-objective reward neural network comprises:
processing the reward input using the base neural network to generate a shared representation of the reward input; and
processing the shared representation using the respective output head for each of the plurality of objectives to generate the respective reward scores for the plurality of objectives.

8. The method of claim 7, wherein the respective output head for each of the plurality of objectives comprises a respective linear layer having a respective weight tensor.

9. The method of claim 8, wherein processing the shared representation using the respective output head for each of the plurality of objectives to generate the respective reward scores for the plurality of objectives comprises:
processing the shared representation using a combined linear layer that has a combined weight tensor composed of the respective weight tensors for the respective linear layers for each of the plurality of objectives to generate the respective reward scores for the plurality of objectives.

10. The method of claim 7, wherein the base neural network is a language model neural network and wherein the shared representation is a representation of a last token in the reward input generated by the language model neural network.

11. The method of claim 1, wherein generating, from the respective reward scores for each of the plurality of objectives, a combined reward score comprises computing a weighted sum of the respective reward scores for each of the plurality of objectives.

12. The method of claim 1, wherein training the neural network through reinforcement learning using the combined reward scores for the training network outputs comprises training the neural network on an objective that includes a first term that encourages the neural network to assign higher likelihoods to training network outputs that have higher combined rewards.

13. The method of claim 12, wherein the objective includes a second term that penalizes the neural network for generating likelihoods that deviate from likelihoods generated by a reference neural network.

14. The method of claim 1, wherein each of the plurality of objectives has a corresponding loss function, and wherein the multi-objective neural network has been trained on, for each of the plurality of objectives, a respective training data set for the objective using the corresponding loss function for the objective.

15. The method of claim 14, wherein plurality of objectives includes a first objective that has a corresponding loss function that is a pair-wise loss function that compares respective reward scores for the first objective for two reward inputs and a second objective that has a corresponding loss function that is a point-wise loss function that measures a respective reward score for the second objective for a single reward input.

16. The method of claim 14, wherein the respective training data sets for the plurality of objectives have been generated by prompting a trained language model neural network.

17. The method of claim 15, further comprising, prior to the training of the neural network, training the multi-objective reward model neural network on the respective training data sets for the plurality of objectives.

18. The method of claim 17, wherein the training of the multi-objective reward model neural network comprises, at a particular reward neural network training step:
obtaining a batch of training reward inputs, wherein each training reward input corresponds to a respective one of the plurality of objectives, and wherein the training reward inputs in the batch comprise:
a training reward input for the second objective, and
a pair of training reward inputs for the first objective;
processing each of the training reward inputs in the batch using the reward model neural network to generate a respective training reward score for each of the training reward inputs; and
training the reward neural network using the training reward scores, comprising:
for the second objective, determining a gradient of the point-wise loss function for the second objective using the training reward score for the training reward input for the first objective;
for the first objective, determining a gradient of the pair-wise loss function for the first objective using the training reward scores for the pair of training reward inputs for the first objective; and
training the reward neural network using the gradients for the first and second objectives.

19. A system comprising one or more computers and one or more storage devices storing instructions that when executed by the one or more computers cause the one more computers to perform operations comprising:
training, through reinforcement learning, a neural network that is configured to receive a network input and to process the network input to generate a network output, the training comprising, at each of a plurality of training steps:
obtaining one or more training network inputs for the training step;
processing the training network inputs using the neural network to generate one or more training network outputs for each of the training network inputs;
for each training network output, processing a reward input comprising the training network output using a multi-objective reward neural network to generate a respective reward score for each of a plurality of objectives;
for each training network output, generating, from the respective reward scores for each of the plurality of objectives, a combined reward score; and
training the neural network through reinforcement learning using the combined reward scores for the training network outputs.

20. One or more non-transitory computer storage media storing instructions that when executed by one or more computers cause the one more computers to perform operations comprising:
training, through reinforcement learning, a neural network that is configured to receive a network input and to process the network input to generate a network output, the training comprising, at each of a plurality of training steps:
obtaining one or more training network inputs for the training step;
processing the training network inputs using the neural network to generate one or more training network outputs for each of the training network inputs;
for each training network output, processing a reward input comprising the training network output using a multi-objective reward neural network to generate a respective reward score for each of a plurality of objectives;
for each training network output, generating, from the respective reward scores for each of the plurality of objectives, a combined reward score; and
training the neural network through reinforcement learning using the combined reward scores for the training network outputs.
